(19) United States
(12) Patent Application Publication
(10) Pub. No.: US 2024/0177400 A1
(43) Pub. Date: May 30, 2024

(54) TEXTURE OPACITY OPTIMIZATIONS FOR OPTICAL SEE-THROUGH AR DISPLAYS

(71) Applicant: Intel Corporation, Santa Clara, CA (US)

(72) Inventor: Akshay Jindal, Bellevue, WA (US)

(21) Appl. No.: 18/432,970

(22) Filed: Feb. 5, 2024

(51) Int. Cl. G06T 15/04; G02B 27/01; G06T 7/40; G06T 19/00; G06V 10/74

(52) U.S. Cl. CPC G06T 15/04; G02B 27/017; G06T 7/40; G06T 19/006; G06V 10/761; G02B 2027/0138

(57) ABSTRACT

Systems, apparatuses and methods may provide for technology that determines a texture similarity between a target output image and an initial rendered image, updates one or more scene parameters to increase the texture similarity between the target output image and the initial rendered image, generates a modified rendered image based on the updated scene parameter(s), and sends the modified rendered image to one or more displays of an augmented reality (AR) headset, wherein the modified rendered image visually blends with an environmental image to obtain the target output image.

### BACKGROUND

Optical-see through augmented reality (OST-AR) displays are a class of displays that use beam splitters or waveguides to add light from the display to light coming from the environment. The result creates a perception of virtual objects coexisting with reality. Due to the additive nature of OST-AR displays, the resulting color is a mixture of the displayed light and environment light, resulting in virtual objects appearing transparent rather than opaque. This transparency of virtual objects may degrade immersion, user performance, and visual realism.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of an augmented reality (AR) headset according to an embodiment;

FIG. 2 is a comparative illustration of an example of conventional rendering results and enhanced rendering results according to embodiments;

FIG. 3 is a block diagram of an example of a differentiable rendering pipeline according to an embodiment;

FIG. 4 is a flowchart of an example of a method of operating an AR headset according to an embodiment;

FIG. 5 is a block diagram of an example of a performance-enhanced AR headset according to an embodiment;

FIG. 6 is an illustration of an example of a semiconductor package apparatus according to an embodiment;

FIG. 7 is a block diagram of an example of a processor according to an embodiment; and

FIG. 8 is a block diagram of an example of a multi-processor based computing system according to an embodiment.

### DETAILED DESCRIPTION

The technology described herein improves the opacity of texture-mapped virtual objects on optical see-through augmented reality (OST-AR) displays by utilizing recent advances in differentiable rendering and texture similarity metrics. More particularly, certain variations of a texture map when blended with the background can appear to be semantically identical to the original texture but are perceived as more opaque. These variations can be found by optimizing the pixel values of texture maps to maximize the opacity of the rendered image while minimizing differences in texture appearance. This approach uses a camera on the display to capture an image of the background and does not require any other changes to the display hardware (e.g., working well within the luminance range of existing and future OST AR displays).

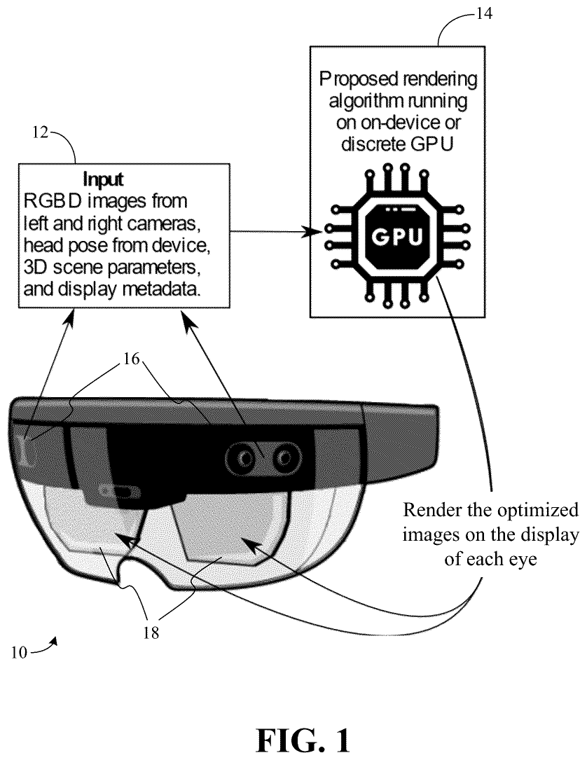

FIG. 1 shows an augmented reality (AR) headset 10 (e.g., optical see-through augmented reality/OST-AR display) that may be used in a wide variety of applications such as retail, advertising, fashion, manufacturing, architecture, visualization, automotive (e.g., heads-up display/HUD), gaming, and so forth. An input 12 to the AR headset 10 includes RGBD (red, green, blue, depth) images from left and right eye cameras 16, head pose data, 3D (three-dimensional) scene parameters (e.g., texture maps), and display metadata. The illustrated AR headset 10 includes a processor 14 (e.g., discrete GPU/graphics processing unit, tensor processing unit/TPU, network processing unit/NPU, versatile processing unit/VPU, etc.) that executes a set of instructions to render optimized images on left and right eye displays 18 of the AR headset 10.

In general, an estimate of a background image can be captured using the left and right eye cameras 16. The background image can then be mapped to physical units using a camera profile and combined with the rendered image, which is also mapped to physical units using display transfer functions and transmittance.

More particularly, execution of the instructions by the processor 14 causes the processor 14 and/or the AR headset 10 to determine a texture similarity between a target output image and an initial rendered image, update one or more scene parameters (e.g., texture maps) to increase the texture similarity between the target output image and the initial rendered image, and generate a modified rendered image based on the updated scene parameter(s). Execution of the instructions by the processor 14 can also cause the processor 14 and/or the AR headset 10 to send the modified rendered image the left and right eye displays 18 of the AR headset 10, wherein the modified rendered image visually blends with an environmental image to obtain the target output image. Adjusting the scene parameters to increase texture similarity results in virtual objects appearing opaque rather than transparent (e.g., recreating occlusion), which in turn improves immersion, user performance and virtual realism.

For example, the image presented on the displays 18 of the AR headset 10 can be denoted as D (e.g., initial rendered image) and the image of the real-world environment directly behind the displays 18 can be denoted as E (e.g., environmental image). The final image I, as perceived by the eye, is given by:

I=E·α+D·(1−α),

Where α is the transmittance factor of the display surface. While the goal of an AR application is to present D as an opaque image (i.e., I=D), due to the additive nature of the display, it may not be possible to achieve perfect opaqueness. The technology described herein relaxes the constraint of equality in the above equation and uses differentiable rendering to update scene parameters such that the new perceived image I′ (e.g., target output image) appears texturally similar to D. Assuming the displayed image D is generated by a renderer R using scene parameters S,

R(S)=D,

Scene parameters (S) such as texture maps can be optimized to generate a new image D′ (e.g., modified rendered image), which when blended with the environment, appears texturally similar to the original image D. In other words,

I′=E·α+D′·(1−α)|minimize T(D,I′), subject to 0≤D′≤L,

Where L is the peak luminance of the display and T is a measure of texture difference. One candidate for T could be a Gram matrix correlation of VGG (Visual Geometry Group) features as commonly used in texture synthesis literature. By optimizing for texture similarity of the entire image instead of per-pixel luminance values, the perceived opacity of the rendered image can be significantly increased while staying within the dynamic range of the displays.

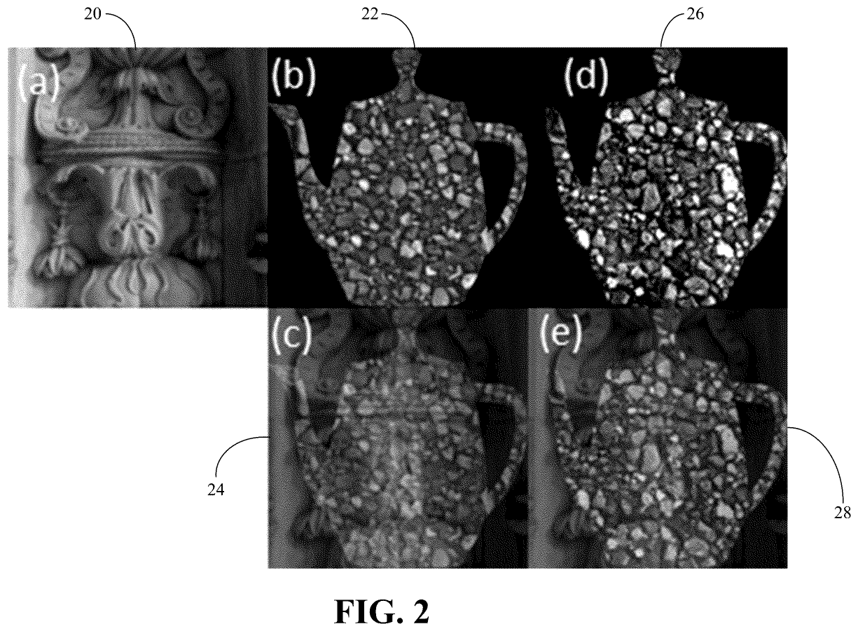

Turning now to FIG. 2, an environmental image 20 (e.g., E) of a real-world background (e.g., sculpture) is shown. An initial rendered image 22 (e.g., D, as rendered on a conventional display) is of a textured teapot in the illustrated example. A blended image 24 (e.g., I, as seen by the viewer on a conventional display) demonstrates that the teapot is difficult to distinguish from the environmental image 20 (e.g., 50/50 reflectance: transmittance ratio). By contrast, a modified rendered image 26 (e.g., =D′) from a pipeline as described herein is generated based on updated scene parameters. The modified rendered image 26 minimizes the texture difference between the initial rendered image 22 and a target output image 28 (e.g., I′). Thus, the teapot blends seamlessly with the background and is much easier to distinguish from the environmental image 20 due to a greater opacity (e.g., opacity exceeds a threshold).

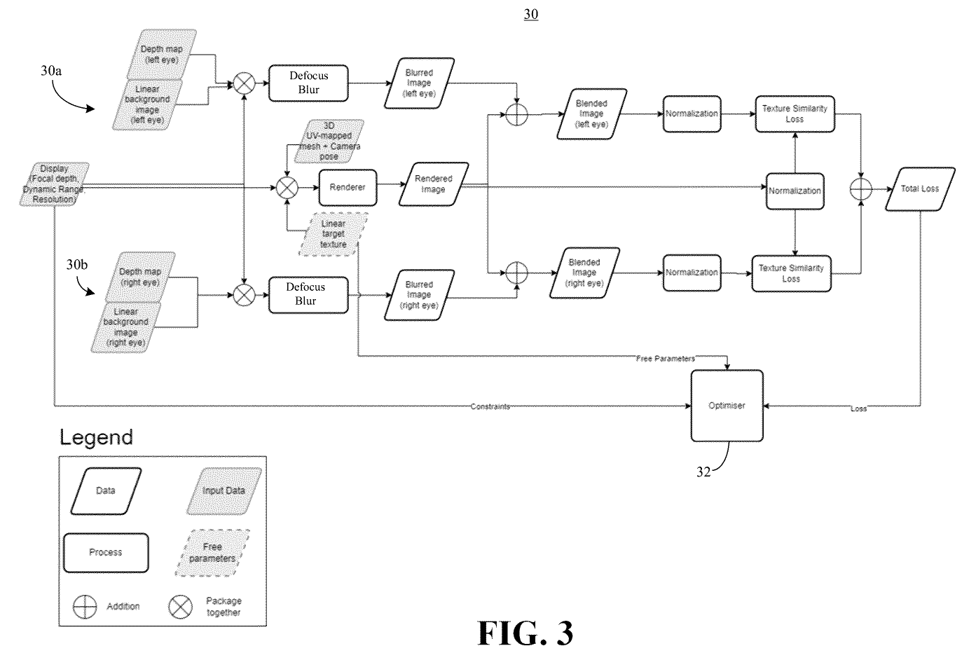

FIG. 3 shows a differentiable rendering pipeline 30 (30a, 30b) that optimizes the opacity of texture maps while preserving their textural appearance. The pipeline 30 can be used for offline or online rendering depending on the performance of an optimizer 32. In one example, the pipeline 30 can map an environmental image to physical units using a camera profile and combine the environmental image with a rendered image (e.g., also mapped to physical units using display transfer functions and transmittance) to solve the above optimization. The differentiable rendering pipeline 30 includes a left eye portion 30a and a right eye portion 30b. Depending on the efficiency of the optimizer 32, texture maps can be updated every frame or once during initialization.

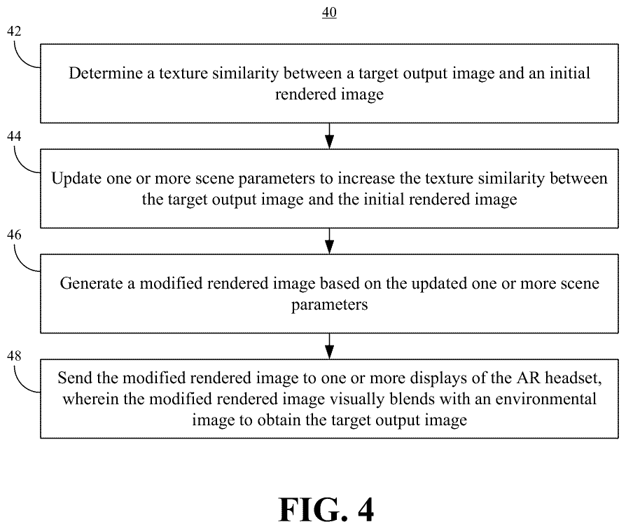

FIG. 4 shows a method 40 of operating an AR headset. The method 40 may generally be implemented in an AR headset such as, for example, the AR headset 10 (FIG. 1) and/or a pipeline such as, for example, the differentiable rendering pipeline 30 (FIG. 3), already discussed. More particularly, the method 40 may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 40 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, micro-code, state-setting data, configuration data for integrated circuitry, state information that personalizes electronic circuitry and/or other structural components that are native to hardware (e.g., host processor, central processing unit/CPU, microcontroller, etc.).

Illustrated processing block 42 determines a texture similarity between a target output image and an initial rendered image. Block 44 provides for updating one or more scene parameters (e.g., texture maps) to increase the texture similarity (e.g., minimize the texture difference) between the target output image and the initial rendered image. In one example, block 44 updates the scene parameter(s) based on a peak luminance of one or more displays. The scene parameter(s) may also be updated with respect to an entirety of the target output image. Block 46 generates a modified rendered image based on the updated scene parameter(s). In an embodiment, the opacity of the modified rendered image in the target output image is relatively high (e.g., exceeds a threshold). Block 48 sends the modified rendered image to one or more displays of the AR headset, wherein the modified rendered image visually blends with an environmental image to obtain the target output image. In one example, block 48 obtains the environmental image from one or more of a left eye camera or a right eye camera of the AR headset. The method of 40 therefore enhances performance at least to the extent that adjusting the scene parameters to increase texture similarity results in virtual objects appearing opaque rather than transparent (e.g., recreating occlusion), which in turn improves immersion, user performance and virtual realism.

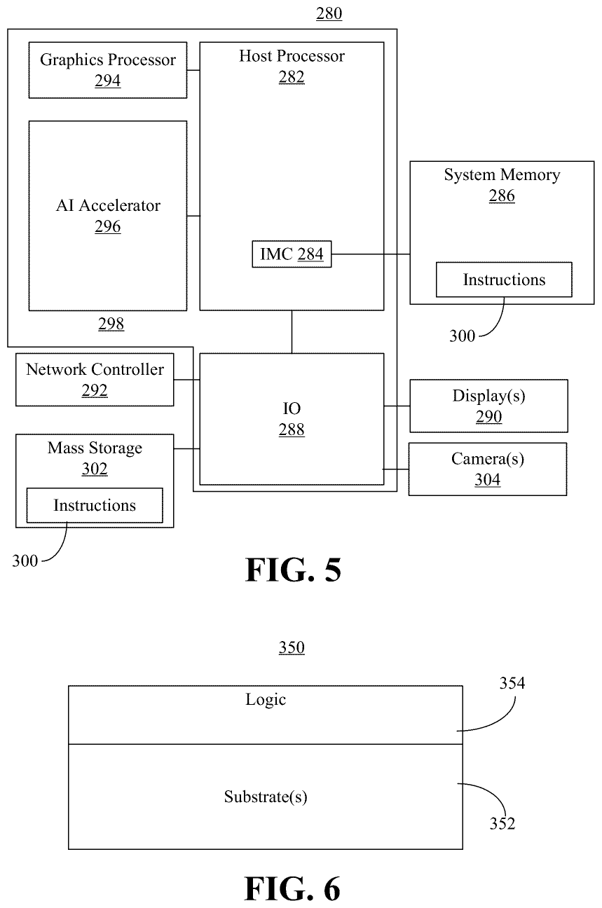

Turning now to FIG. 5, a performance-enhanced AR headset 280 is shown. The headset 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the headset 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, one or more displays 290 (e.g., OST-AR displays, touch screens, liquid crystal displays/LCDs, light emitting diode/LED displays), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an artificial intelligence (AI) accelerator 296 (e.g., specialized processor) into a system on chip (SoC) 298. The AR headset 280 may also include one or more cameras 304 to obtain an environmental image.

The SoC 298 retrieves executable program instructions 300 from the system memory 286 and/or the mass storage 302 and executes the instructions 300 to perform one or more aspects of the method 40 (FIG. 4), already discussed. Thus, execution of the instructions 300 by the SoC 298 causes the SoC 298 and/or the AR headset 280 to determine a texture similarity between a target output image and an initial rendered image, update one or more scene parameters to increase the texture similarity between the target output image and the initial rendered image, and generate a modified rendered image based on the updated one or more scene parameters. Execution of the instructions 300 by the SoC 298 also causes the SoC 298 and/or the AR headset 280 to blend the modified rendered image with the environmental image to obtain the target output image and send the target output image to the one or more displays 290. The AR headset is therefore considered performance-enhanced at least to the extent that adjusting the scene parameters to increase texture similarity results in virtual objects appearing opaque rather than transparent (e.g., recreating occlusion), which in turn improves immersion, user performance and virtual realism.

FIG. 6 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 40 (FIG. 4), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

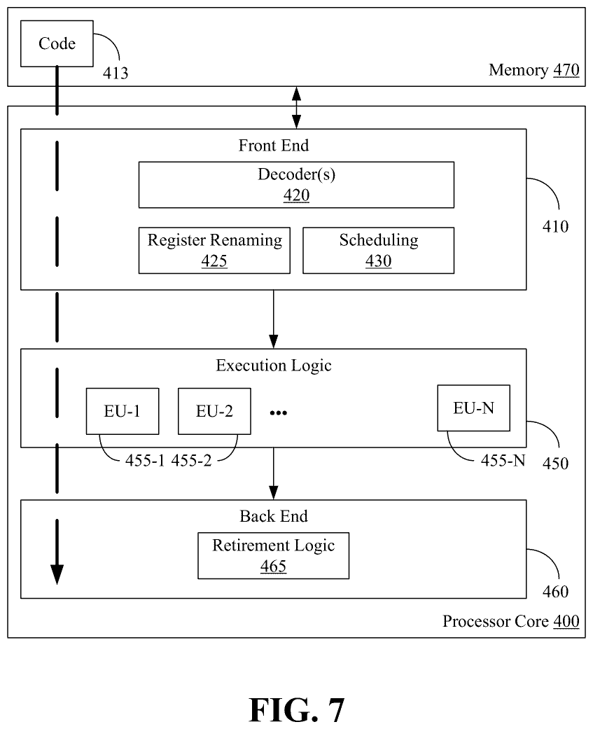

FIG. 7 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 7, a processing element may alternatively include more than one of the processor core 400 illustrated in FIG. 7. The processor core 400 may be a single-threaded core or, for at least one embodiment, the processor core 400 may be multithreaded in that it may include more than one hardware thread context (or “logical processor”) per core.

FIG. 7 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 40 (FIG. 4), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 7, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

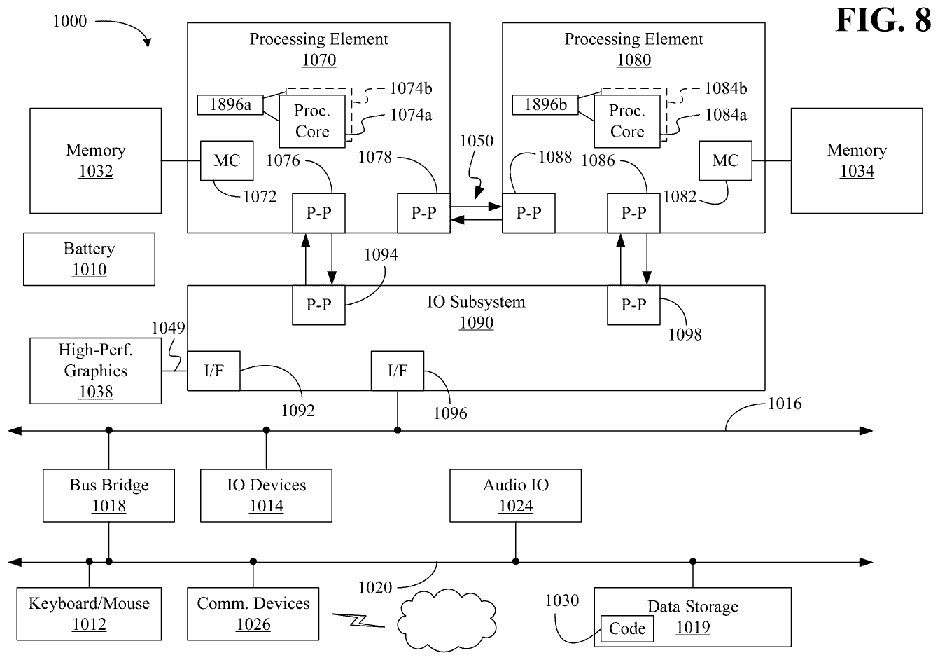

Referring now to FIG. 8, shown is a block diagram of a computing system 1000 embodiment in accordance with an embodiment. Shown in FIG. 8 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 8 may be implemented as a multi-drop bus rather than point-to-point interconnect.

As shown in FIG. 8, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 7.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 8, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 8, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 8, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 40 (FIG. 4), already discussed. Further, an audio I/O 1024 may be coupled to second bus 1020 and a battery 1010 may supply power to the computing system 1000.

Note that other embodiments are contemplated. For example, instead of the point-to-point architecture of FIG. 8, a system may implement a multi-drop bus or another such communication topology. Also, the elements of FIG. 8 may alternatively be partitioned using more or fewer integrated chips than shown in FIG. 8.

### ADDITIONAL NOTES AND EXAMPLES

Example 1 includes an augmented reality (AR) headset comprising one or more displays, a processor coupled to the one or more displays, and a memory coupled to the processor, the memory including a set of instructions, which when executed by the processor, cause the processor to determine a texture similarity between a target output image and an initial rendered image, update one or more scene parameters to increase the texture similarity between the target output image and the initial rendered image, generate a modified rendered image based on the updated one or more scene parameters, and send the modified rendered image to the one or more displays, wherein the modified rendered image visually blends with an environmental image to obtain the target output image.

Example 2 includes the AR headset of Example 1, wherein an opacity of the modified rendered image in the target output image exceeds a threshold.

Example 3 includes the AR headset of Example 1, wherein the one or more scene parameters are to include texture maps.

Example 4 includes the AR headset of Example 1, wherein the one or more scene parameters are updated based on a peak luminance of the one or more displays.

Example 5 includes the AR headset of Example 1, wherein the one or more scene parameters are updated with respect to an entirety of the target output image.

Example 6 includes the AR headset of any one of Examples 1 to 5, further including a left eye camera, and a right eye camera, wherein the instructions, when executed, further cause the processor to obtain the second environmental image from one or more of the left eye camera or the right eye camera.

Example 7 includes at least one computer readable storage medium comprising a set of instructions, which when executed by an augmented reality (AR) headset, cause the AR headset to determine a texture similarity between a target output image and an initial rendered image, update one or more scene parameters to increase the texture similarity between the target output image and the initial rendered image, generate a modified rendered image based on the updated one or more scene parameters, and send the modified rendered image to one or more displays of the AR headset, wherein the modified rendered image is to visually blend with an environmental image to obtain the target output image.

Example 8 includes the at least one computer readable storage medium of Example 7, wherein an opacity of the modified rendered image in the target output image exceeds a threshold.

Example 9 includes the at least one computer readable storage medium of Example 7, wherein the one or more scene parameters are to include texture maps.

Example 10 includes the at least one computer readable storage medium of Example 7, wherein the one or more scene parameters are updated based on a peak luminance of the one or more displays.

Example 11 includes the at least one computer readable storage medium of Example 7, wherein the one or more scene parameters are updated with respect to an entirety of the target output image.

Example 12 includes the at least one computer readable storage medium of any one of Examples 7 to 11, wherein the instructions, when executed, further cause the AR headset to obtain the environmental image from a camera of the AR headset.

Example 13 includes the at least one computer readable storage medium of Example 12, wherein the environmental image is obtained from a left eye camera.

Example 14 includes the at least one computer readable storage medium of Example 12, wherein the environmental image is obtained from a right eye camera.

Example 15 includes a method of operating a performance-enhanced augmented reality (AR) headset, the method comprising determining a texture similarity between a target output image and an initial rendered image, updating one or more scene parameters to increase the texture similarity between the target output image and the initial rendered image, generating a modified rendered image based on the updated one or more scene parameters, and sending the modified rendered image to one or more displays of the AR headset, wherein the modified rendered image visually blends with an environmental image to obtain the target output image.

Example 16 includes the method of Example 15, wherein an opacity of the modified rendered image in the target output image exceeds a threshold.

Example 17 includes the method of Example 15, wherein the one or more scene parameters include texture maps.

Example 18 includes the method of Example 15, wherein the one or more scene parameters are updated based on a peak luminance of a display.

Example 19 includes the method of Example 15, wherein the one or more scene parameters are updated with respect to an entirety of the target output image.

Example 20 includes the method of any one of Examples 15 to 19, further including obtaining the environmental image one or more of a left eye camera or a right eye camera.

Example 21 includes and apparatus comprising means for performing the method of any one of Examples 15 to 20.

The technology described herein therefore eliminates inconsistencies in color reproduction and eye focus and achieves display compactness (e.g., as opposed approaches that may physically block environment light in a spatially varying manner). The technology described herein can also be applied to individual virtual objects (e.g., as opposed to approaches that may involve global light reduction). Moreover, the technology described herein eliminate the need to boost the luminance of virtual objects relative to the luminance of the real environment (e.g., as in radiometric compensation techniques). Rather, the technology described herein is practical for form, battery, and eye safety constraints of OST-AR displays. Indeed, the technology described herein is suitable for AR applications such as metaverse applications, which call for the virtual object to blend seamlessly with the environment.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An augmented reality (AR) headset comprising:
one or more displays;
a processor coupled to the one or more displays; and
a memory coupled to the processor, the memory including a set of instructions, which when executed by the processor, cause the processor to:
determine a texture similarity between a target output image and an initial rendered image,
update one or more scene parameters to increase the texture similarity between the target output image and the initial rendered image,
generate a modified rendered image based on the updated one or more scene parameters, and
send the modified rendered image to the one or more displays, wherein the modified rendered image is to visually blend with an environmental image to obtain the target output image.

2. The AR headset of claim 1, wherein an opacity of the modified rendered image in the target output image exceeds a threshold.

3. The AR headset of claim 1, wherein the one or more scene parameters are to include texture maps.

4. The AR headset of claim 1, wherein the one or more scene parameters are updated based on a peak luminance of the one or more displays.

5. The AR headset of claim 1, wherein the one or more scene parameters are updated with respect to an entirety of the target output image.

6. The AR headset of claim 1, further including:
a left eye camera; and
a right eye camera, wherein the instructions, when executed, further cause the processor to obtain the second environmental image from one or more of the left eye camera or the right eye camera.

7. At least one computer readable storage medium comprising a set of instructions, which when executed by an augmented reality (AR) headset, cause the AR headset to:
determine a texture similarity between a target output image and an initial rendered image;
update one or more scene parameters to increase the texture similarity between the target output image and the initial rendered image;
generate a modified rendered image based on the updated one or more scene parameters; and
send the modified rendered image to one or more displays of the AR headset, wherein the modified rendered image is to visually blend with an environmental image to obtain the target output image.

8. The at least one computer readable storage medium of claim 7, wherein an opacity of the modified rendered image in the target output image exceeds a threshold.

9. The at least one computer readable storage medium of claim 7, wherein the one or more scene parameters are to include texture maps.

10. The at least one computer readable storage medium of claim 7, wherein the one or more scene parameters are updated based on a peak luminance of the one or more displays.

11. The at least one computer readable storage medium of claim 7, wherein the one or more scene parameters are updated with respect to an entirety of the target output image.

12. The at least one computer readable storage medium of claim 7, wherein the instructions, when executed, further cause the AR headset to obtain the environmental image from a camera of the AR headset.

13. The at least one computer readable storage medium of claim 12, wherein the environmental image is obtained from a left eye camera.

14. The at least one computer readable storage medium of claim 12, wherein the environmental image is obtained from a right eye camera.

15. A method comprising:
determining a texture similarity between a target output image and an initial rendered image;
updating one or more scene parameters to increase the texture similarity between the target output image and the initial rendered image;
generating a modified rendered image based on the updated one or more scene parameters; and
sending the modified rendered image to one or more displays of an augmented reality (AR) headset, wherein the modified rendered image visually blends with an environmental image to obtain the target output image.

16. The method of claim 15, wherein an opacity of the modified rendered image in the target output image exceeds a threshold.

17. The method of claim 15, wherein the one or more scene parameters include texture maps.

18. The method of claim 15, wherein the one or more scene parameters are updated based on a peak luminance of a display.

19. The method of claim 15, wherein the one or more scene parameters are updated with respect to an entirety of the target output image.

20. The method of claim 15, further including obtaining the environmental image one or more of a left eye camera or a right eye camera.
